(19) United States
(12) Patent Application Publication
(10) Pub. No.: US 2026/0187734 A1
(43) Pub. Date: Jul. 2, 2026

(54) MACHINE LEARNING BASED SYSTEM AND METHOD FOR DOCUMENT CATEGORIZATION AND DATA EXTRACTION

(71) Applicant: HIGHRADIUS CORPORATION, Houston, TX (US)

(72) Inventors: Mansi Raj, Hyderabad (IN); Soumyajit Dey, Hyderabad (IN); Gagan Agarwal, Hyderabad (IN); Sumit Gupta, Hyderabad (IN); Pratyush Amrit, Hyderabad (IN); Srajan Agarwal, Hyderabad (IN)

(21) Appl. No.: 19/004,537

(22) Filed: Dec. 30, 2024

(51) Int. Cl. G06Q 40/12; G06F 16/906; G06F 18/213

(52) U.S. Cl. CPC G06Q 40/12; G06F 16/906; G06F 18/213

(57) ABSTRACT

A machine learning based (ML-based) method and system for automatically categorizing documents, is disclosed. Initially, the documents are obtained from data sources and pre-processed to generate the pre-processed data associated with documents. The documents are classified as at least one of: relevant financial statements and non-relevant financial statements, based on the pre-processed data using a voting classifier with machine learning (ML) models. The classified non-relevant financial statements are classified into the relevant financial statements using at least one of: a rule-based classification technique and a classifier model, to mitigate false positive categorization of the documents. The re-categorized electronic documents are provided as an output, to users on user interfaces associated with electronic devices associated with the users. The financial statements are classified using TF-IDF vectorizer with voting classifier based on contents of the documents. The ML-based system utilizes sophisticated techniques for detecting tables precisely using coordinate mapping.

### FIELD OF INVENTION

Embodiments of the present disclosure relate to machine learning based (ML-based) systems, and more particularly relates to a ML-based method and system for automatically categorizing one or more documents and extracting data from the one or more documents.

### BACKGROUND

In the financial documentation landscape, the need for advanced categorization of critical document including at least one of: balance sheets, income statements, and cash flow statements, has become increasingly urgent. The challenge intensifies while considering an extraction of relevant fields from these financial statements for credit scoring purposes. The lack of a comprehensive classification and extraction framework significantly hampers the ability to determine the nature of various financial documents accurately. This issue is further complicated by the wide variety of document types involved, underscoring the need for an advanced machine learning (ML) classification model to effectively resolve these challenges.

The significance of accurate financial statement classification cannot be overstated, particularly, the financial statement classification directly impacts a credit assessment process. An effective classification system is essential for distinguishing between relevant financial statements and those that do not contribute meaningful data. Presently, a process utilizes convolutional neural networks (CNNs) with the Darknet framework to identify tables within images, combined with Paddle Optical Character Recognition (OCR) for text extraction. This approach requires matching the extracted text against a predefined list of synonyms to classify the financial documents. However, the process was less accurate, time-consuming, and demanded manual effort to maintain the synonym list. Furthermore, the application of the process is restricted to text and image-based PDFs.

Hence, there is a need for an improved machine learning based (ML-based) system and method for automatically categorizing one or more documents and extracting data from the one or more documents, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) method for automatically categorizing one or more documents and extracting data from the one or more documents, is disclosed. The ML-based method comprises obtaining, by one or more hardware processors, the one or more documents from one or more data sources.

The ML-based method further comprises pre-processing, by the one or more hardware processors, the one or more documents to generate pre-processed data associated with the one or more documents.

The ML-based method further comprises classifying, by the one or more hardware processors, the one or more documents as at least one of: one or more relevant financial statements and one or more non-relevant financial statements, based on the pre-processed data using a voting classifier with one or more machine learning (ML) models.

The ML-based method further comprises re-classifying, by the one or more hardware processors, the classified one or more non-relevant financial statements into the one or more relevant financial statements using at least one of: a rule-based classification technique and a classifier model, to mitigate false positive categorization of the one or more documents.

The ML-based method further comprises providing, by the one or more hardware processors, the re-categorized one or more electronic documents as an output, to one or more users on one or more user interfaces associated with one or more electronic devices associated with the one or more users.

In an embodiment, pre-processing the data associated with the one or more documents comprises extracting, by the one or more hardware processors, one or more texts along with one or more coordinates of each word within the one or more documents, using a parsing mechanism.

In another embodiment, pre-processing the data associated with the one or more documents further comprises converting, by the one or more hardware processors, the extracted one or more texts into one or more structured tabular formats, by: (a) identifying, by the one or more hardware processors, one or more potential table regions by analyzing the one or more documents using one or more pre-defined rules and heuristics, wherein the one or more pre-defined rules are based on at least one of: one or more domain knowledges and one or more inherent properties of table structures comprising spatial arrangements of at least one of: the one or more texts, one or more lines, and one or more cell formatting, and wherein the spatial arrangements are derived from the one or more coordinates of each word within the one or more documents; (b) identifying, by the one or more hardware processors, one or more boundaries of one or more tables by analyzing the spatial arrangements; (c) grouping, by the one or more hardware processors, one or more clustered characters associated with the one or more texts, into one or more entities, wherein resultant coordinates are derived to indicate each entity of the one or more entities in a two dimensional space; (d) setting, by the one or more hardware processors, at least one of: a first threshold value on a first coordinate of the resultant coordinates to differentiate each column of one or more columns, and a second threshold value on a second coordinate of the resultant coordinates to differentiate each row of one or more rows; (e) analyzing, by the one or more hardware processors, the resultant coordinates of the one or more entities for determining alignment of the one or more texts; (f) categorizing, by the one or more hardware processors, the one or more entities into one or more data types, wherein the one or more data types comprises at least one of: one or more strings, one or more integers, and one or more date type data; (g) upon determining the alignment of the one or more texts, identifying, by the one or more hardware processors, at least one of: a start point and an end point, of the one or more tables based on the resultant coordinates and the one or more data types; (h) segmenting, by the one or more hardware processors, the one or more entities into at least one of: the one or more rows and the one or more columns, based on the one or more data types and the one or more resultant coordinates, to identify at least one of one or more headers and one or more labels of the one or more tables; and (i) converting, by the one or more hardware processors, the extracted one or more texts into one or more structured tabular formats based on the start point, the end point, and the segmented one or more entities.

In yet another embodiment, pre-processing the data associated with the one or more documents further comprises filtering, by the one or more hardware processors, at least one of: one or more common language stop words, one or more non-alphabetic characters, and one or more special characters, from the one or more texts to generate the one or more pre-processed data, based on one or more custom noise removal rules.

In yet another embodiment, classifying the one or more documents comprises: (a) obtaining, by the one or more hardware processors, the pre-processed data; (b) converting, by the one or more hardware processors, one or more strings indicating textual data into a numerical format, using a Term Frequency-Inverse Document Frequency (TFIDF) vectorizer, wherein the TFIDF vectorizer is configured to utilize one or more features to indicate the textual data; (c) predicting, by the one or more hardware processors, an issue of class imbalance by adjusting at least one of: one or more class weights and one or more hyperparameters, using a first ML model of the one or more ML models; (d) rectifying, by the one or more hardware processors, potential losses in precision due to the class imbalance predicted by the first ML model, using a second ML model of the one or more ML models; (e) combining, by the one or more hardware processors, one or more votes provided by at least one of: the first ML model and the second ML model, for predicted classes associated with the one or more financial statements, using a voting classifier with majority voting mechanism; and (f) classifying, by the one or more hardware processors, the one or more documents as the one or more financial statements based on a majority of votes provided by the at least one of: the first ML model and the second ML model.

In yet another embodiment, the ML-based method further comprises training, by the one or more hardware processors, the one or more ML models, by: (a) obtaining, by the one or more hardware processors, one or more training datasets comprising one or more types of the one or more documents; (b) training, by the one or more hardware processors, the one or more ML models independently on the one or more training datasets for classifying the one or more documents; and (c) fine-tuning, by the one or more hardware processors, at least one of: the first ML model to manage the class imbalance, and the second ML model to maintain the precision in managing the class imbalance.

In yet another embodiment, re-classifying the classified one or more non-relevant financial statements into the one or more relevant financial statements, comprises at least one of: (a) determining, by the one or more hardware processors, whether at least one of: one or more string columns, one or more integer columns, in one or more tables within the one or more documents, and a size of the one or more tables, are below a threshold value to classify the one or more documents as the one or more relevant financial statements, using at least one of: the rule-based classification technique and the classifier model; (b) re-classifying, by the one or more hardware processors, the one or more non-relevant financial statements into the one or more relevant financial statements when the one or more non-relevant financial statements are classified based on a single category of data in the one or more documents, using at least one of: the rule-based classification technique and the classifier model; and (c) re-classifying, by the one or more hardware processors, the one or more non-relevant financial statements into the one or more relevant financial statements when the one or more non-relevant financial statements are classified based on a plurality of categories of the data in the one or more documents, using at least one of: the rule-based classification technique and the classifier model.

In yet another embodiment, the ML-based method further comprises re-training, by the one or more hardware processors, the one or more ML models by: (a) obtaining, by the one or more hardware processors, one or more assessments of ML model predictions on data samples, from the one or more users; (b) identifying, by the one or more hardware processors, differences between the ML model predictions and the one or more assessments obtained from the one or more users, to determine whether the one or more ML models need to be optimized on the predictions; and (c) re-training, by the one or more hardware processors, the one or more ML models by at least one of: updating the pre-processed data, adjusting feature selection criteria, adjusting the one or more hyperparameters, based on one or more feedback received on the predictions.

In one aspect, a machine learning based (ML-based) system for automatically categorizing one or more documents and extracting data from the one or more documents, is disclosed. The ML-based system includes one or more hardware processors and a memory coupled to the one or more hardware processors. The memory includes a plurality of subsystems in the form of programmable instructions executable by the one or more hardware processors.

The plurality of subsystems comprises a document obtaining subsystem configured to obtain the one or more documents from one or more data sources.

The plurality of subsystems further comprises a document pre-processing subsystem configured to pre-process the one or more documents to generate pre-processed data associated with the one or more documents.

The plurality of subsystems further comprises a document classifying subsystem configured to: (a) classify the one or more documents as at least one of: one or more relevant financial statements and one or more non-relevant financial statements, based on the pre-processed data using a voting classifier with one or more machine learning (ML) models; and (b) re-classify the classified one or more non-relevant financial statements into the one or more relevant financial statements using at least one of: a rule-based classification technique and a classifier model, to mitigate false positive categorization of the one or more documents.

The plurality of subsystems further comprises an output subsystem configured to provide the re-categorized one or more electronic documents as an output, to one or more users on one or more user interfaces associated with one or more electronic devices associated with the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) system for automatically categorizing one or more documents and extracting data from the one or more documents, in accordance with an embodiment of the present disclosure;

FIG. 2 is a detailed view of the ML-based system for automatically categorizing the one or more documents and extracting the data from the one or more documents, in accordance with another embodiment of the present disclosure;

FIG. 3 is an overall architecture of the ML-based system for automatically categorizing the one or more documents and extracting the data from the one or more documents, in accordance with another embodiment of the present disclosure;

FIGS. 4A-4F represent one or more processes for converting the extracted one or more texts into one or more structured tabular formats, in accordance with another embodiment of the present disclosure;

FIG. 5 is an exemplary process flow for automatically categorizing the one or more documents and extracting the data from the one or more documents, in accordance with another embodiment of the present disclosure; and

FIG. 6 is a flow chart illustrating a machine-learning based (ML-based) method for automatically categorizing the one or more documents and extracting the data from the one or more documents, in accordance with an embodiment of the present disclosure;

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

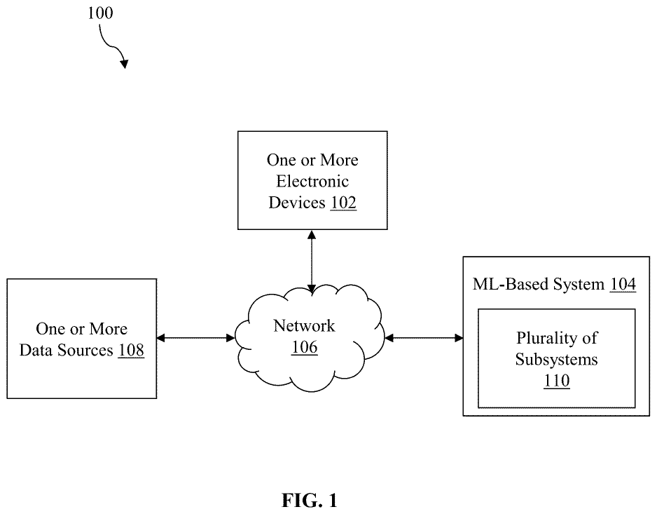

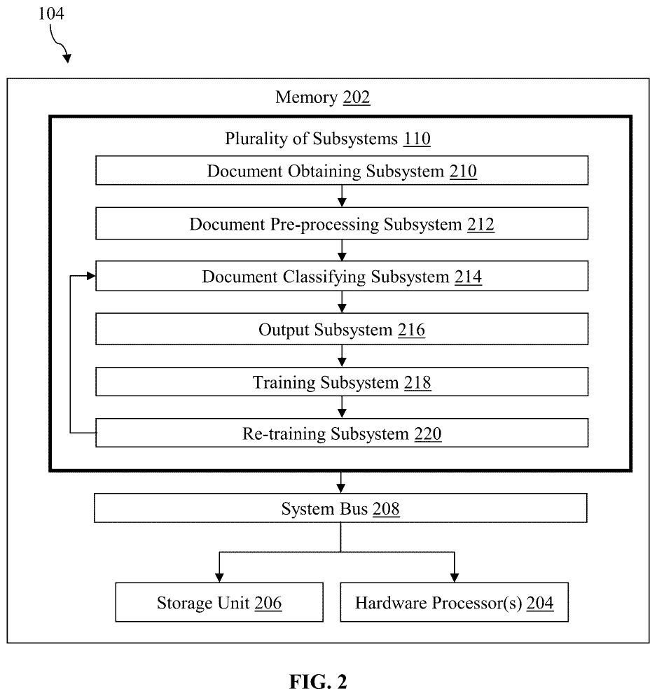

Referring now to the drawings, and more particularly to FIG. 1 through FIG. 6, where similar reference characters denote corresponding features consistently throughout the figures, there are shown preferred embodiments, and these embodiments are described in the context of the following exemplary system and/or method.

FIG. 1 is a block diagram illustrating a computing environment 100 with a machine learning based (ML-based) system 104 for automatically categorizing one or more documents and extracting data from the one or more documents, in accordance with an embodiment of the present disclosure. In an embodiment, the terms one or more documents and one or more financial documents may be used interchangeably. In another embodiment, the one or more documents comprises at least one of: email remittance, Optical Character Recognition (OCR) remittance, payment notes, invoices, remittance advice, remittance documents, bank statements, payment vouchers, payroll documents, credit memos, purchase orders, expense reports, budgets, financial statements, one or more electronic emails, one or more attachments in the one or more electronic emails and the like. According to FIG. 1, the computing environment 100 includes one or more electronic devices 102 that are communicatively coupled to the ML-based system 104 through a network 106. The one or more electronic devices 102 through which one or more users receive output results from the ML-based system 104.

The present invention is configured to automatically categorize the one or more documents and extract the data from the one or more documents. The ML-based system 104 is initially configured to obtain the one or more documents from one or more data sources 108. In an embodiment, the one or more documents may be encrypted and decrypted by the ML-based system 104, so that one or more third party users cannot be authenticated to manipulate the one or more documents.

The ML-based system 104 is further configured to pre-process the one or more documents to generate pre-processed data associated with one or more documents. The ML-based system 104 is further configured to classify the one or more documents as at least one of: one or more relevant financial statements and one or more non-relevant financial statements, based on the pre-processed data using a voting classifier with one or more machine learning (ML) models. The ML-based system 104 is further configured to re-classify the classified one or more non-relevant financial statements into the one or more relevant financial statements using at least one of: a rule-based classification technique and a classifier model, to mitigate false positive categorization of the one or more documents. The ML-based system 104 is further configured to provide the re-categorized one or more electronic documents as an output, to the one or more users on one or more user interfaces associated with the one or more electronic devices 102 associated with the one or more users.

In an embodiment, the one or more users may include at least one of: one or more data analysts, one or more business analysts, one or more cash analysts, one or more financial analysts, one or more collection analysts, one or more debt collectors, one or more professionals associated with cash and collection management, one or more customers, one or more organizations, one or more corporations, one or more parent companies, one or more subsidiaries, one or more joint ventures, one or more partnerships, one or more governmental bodies, one or more associations, and one or more legal entities, and the like.

The ML-based system 104 may be hosted on a central server including at least one of: a cloud server or a remote server. Further, the network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes the one or more data sources 108 communicatively coupled to the ML-based system 104 through the network 106. In an embodiment, the one or more data sources 108 may store the one or more documents. In an embodiment, the one or more data sources 108 includes at least one of: one or more relational databases, one or more object-oriented databases, one or more data warehouses, one or more cloud-based databases, and the like. In another embodiment, a format of the data obtained from the one or more documents may include at least one of: a comma-separated values (CSV) format, a JavaScript Object Notation (JSON) format, an Extensible Markup Language (XML), spreadsheets, and the like.

Furthermore, the one or more electronic devices 102 include at least one of: a local browser, a mobile application, and the like. Furthermore, the one or more end users may use a web application through the local browser, the mobile application to communicate with the ML-based system 104. In an embodiment of the present disclosure, the ML-based system 104 includes a plurality of subsystems 110. Details on the plurality of subsystems 110 have been elaborated in subsequent paragraphs of the present description with reference to FIG. 2.

FIG. 2 is a detailed view of the ML-based system 104 for automatically categorizing the one or more documents and extracting the data from the one or more documents, in accordance with another embodiment of the present disclosure. The ML-based system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes a document obtaining subsystem 210, a document pre-processing subsystem 212, a document classifying subsystem 214, an output subsystem 216, a training subsystem 218, and a re-training subsystem 220. The brief details of the plurality of subsystems 110 have been elaborated in a below table.

| Plurality of | |
|---|---|
| Subsystems 110 | Functionality |
| Document | The document obtaining subsystem 210 is configured to obtain |
| obtaining | the one or more documents from the one or more data sources |
| subsystem 210 | 108. |
| Document pre- | The document pre-processing subsystem 212 is configured to |
| processing | pre-process the one or more documents to generate the pre- |
| subsystem 212 | processed data associated with the one or more documents. |
| Document | The document classifying subsystem 214 is configured to |
| classifying | classify the one or more documents as at least one of: one or |
| subsystem 214 | more relevant financial statements and one or more non- |
| | relevant financial statements, based on the pre-processed data |
| | using a voting classifier with one or more machine learning |
| | (ML) models. |
| | The document classifying subsystem 214 is further configured |
| | to re-classify the classified one or more non-relevant financial |
| | statements into the one or more relevant financial statements |
| | using at least one of: a rule-based classification technique and |
| | a classifier model, to mitigate false positive categorization of |
| | the one or more documents. |
| Output | The output subsystem 216 is configured to provide the re- |
| subsystem 216 | categorized one or more electronic documents as the output, to |
| | the one or more users on the one or more user interfaces |
| | associated with the one or more electronic devices 102 |
| | associated with the one or more users. |
| Training | The training subsystem 218 is configured to train the ML model |
| subsystem 218 | for categorizing the one or more documents. |
| Re-training | The re-training subsystem 220 is configured to re-train the one |
| subsystem 220 | or more ML models by at least one of: updating the pre- |
| | processed data, adjusting feature selection criteria, adjusting |
| | one or more hyperparameters, based on one or more feedback |
| | received on the predictions. |

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the document obtaining subsystem 210 that is communicatively connected to the one or more hardware processors 204. The document obtaining subsystem 210 is configured to obtain the one or more documents from the one or more data sources 108. In an embodiment, the one or more data sources 108 may be one or more financial data repositories, which are integrated in the ML-based system 104. In an embodiment, the one or more documents may be the one or more financial documents (e.g., the one or more remittance documents) that include at least one of: one or more invoices, one or more payment confirmations, one or more general communications, and the like.

In an embodiment, the one or more data sources 108 may store the one or more documents in one or more formats and languages, and the document obtaining subsystem 210 of the ML-based system 104 may be configured to automatically identify and retrieve the one or more relevant documents. The document obtaining subsystem 210 may be configured to store the one or more documents composed in any languages (e.g., English). The document obtaining subsystem 210 may be configured to allow the one or more end users to manually upload the one or more documents through the one or more user interfaces. The document obtaining subsystem 210 may be configured to retrieve the one or more documents from one or more third-party databases through one or more application programming interfaces (APIs). The document obtaining subsystem 210 may be configured to support a range of application programming interfaces (APIs) which may be used for retrieving the one or more documents in one or more formats.

The document obtaining subsystem 210 is configured to handle an input of the data files associated with the one or more documents. In an embodiment, the data files associated with the one or more documents may be in at least one of: a portable document format (PDF), an electronic mail format (EML), a text format, an image format, and the like. In an embodiment, the ML-based system 104 may be configured to provide a feedback to the one or more end users through the one or more electronic devices 102 if the one or more documents are not in a format that may be handled by the ML-based system 104. In an embodiment, the document obtaining subsystem 210 is configured to authenticate the one or more end users and to provide secure access to the one or more documents.

The plurality of subsystems 110 further includes the document pre-processing subsystem 212 that is communicatively connected to the one or more hardware processors 204. The document pre-processing subsystem 212 is configured to pre-process the one or more documents to generate the pre-processed data associated with one or more documents. The document pre-processing subsystem 212 is configured to extract one or more texts along with one or more coordinates of each word within the one or more documents, using a parsing mechanism. The parsing mechanism is configured to accurately interprets the structural elements of PDF and Excel files. In an embodiment, the extraction process of the one or more texts is systematic, as a text extraction module in the document pre-processing subsystem 212 iterates through each page of the one or more documents, meticulously processing and consolidation text from one or more lines and sections.

The text extraction module in the document pre-processing subsystem 212 is configured to seamlessly integrate Optical Character Recognition (OCR) technology as a fallback solution. The capability of OCR may significantly enhance the text extraction module's versatility by enabling the document pre-processing subsystem 212 to extract text from embedded images, thereby ensuring comprehensive coverage of the document's content. In an embodiment, the text extraction module in the document pre-processing subsystem 212 is configured to be adept at a wide array of the one or more documents, ensuring that the text extraction module may accommodate one or more formats and structures without compromising performance. In an embodiment, the text extraction module in the document pre-processing subsystem 212 is configured with robust error handling mechanisms that gracefully manage exceptions during the text extraction process. When the extraction of the one or more texts fails, the text extraction module provides clear and informative error messages, facilitating troubleshooting and enhancing user experience. This reliability is crucial for maintaining the integrity of the data extraction process.

The document pre-processing subsystem 212 with a tabular data processing module is further configured to convert the extracted one or more texts into one or more structured tabular formats. The conversion process involves identifying and extracting relevant tabular data while excluding any non-tabular or irrelevant information. The tabular data processing module in the document pre-processing subsystem 212 ensures that the output data is clean, organized, and ready for analysis or processing.

The document pre-processing subsystem 212 is initially configured to identify one or more potential table regions by analyzing the one or more documents using one or more pre-defined rules and heuristics. In an embodiment, the one or more pre-defined rules are based on at least one of: one or more domain knowledges and one or more inherent properties of table structures including spatial arrangements of at least one of: the one or more texts, one or more lines, and one or more cell formatting. The spatial arrangements are derived from the one or more coordinates of each word within the one or more documents. In an embodiment, the algorithm associated with the document pre-processing subsystem 212 is a rule-based approach, designed to accurately detect and construct the one or more tables from the one or more document formats.

The document pre-processing subsystem 212 is further configured to identify one or more boundaries of the one or more tables by analyzing the spatial arrangements. The identification of the one or more boundaries of the one or more tables ensures that the one or more tables are accurately segmented and constructed, even in complex layouts. Specifically, for PDF documents, the document pre-processing subsystem 212 utilizes a coordinate-based approach to detect and construct the one or more tables.

The document pre-processing subsystem 212 is further configured to group one or more clustered characters associated with the one or more texts, into one or more entities. Resultant coordinates are derived to indicate each entity of the one or more entities in a two dimensional (2D) space. In an embodiment, the one or more entities may be one or more words, one or more numbers, present in the textual data. The grouping of the one or more clustered characters involves identifying the clusters for text elements that are closely aligned both horizontally and vertically, which often indicates the presence of a table. The document pre-processing subsystem 212 is further configured to set at least one of: a first threshold value on a first coordinate (i.e., y coordinate) of the resultant coordinates to differentiate each column of one or more columns, and a second threshold value on a second coordinate (i.e., x coordinate) of the resultant coordinates to differentiate each row of one or more rows.

The document pre-processing subsystem 212 is further configured to analyze the resultant coordinates of the one or more entities for determining alignment of the one or more texts. In an embodiment, when the one or more strings share similar x-coordinates and are followed by integer values (which typically represent data entries), this alignment of the one or more texts may suggest the presence of a table. The document pre-processing subsystem 212 is further configured to categorize the one or more entities into one or more data types. The one or more data types include at least one of: one or more strings, one or more integers, and one or more date type data.

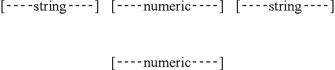

Contracting Income-$21,935,113.58 (Over) Under Billings-$61,720,144,21 The document pre-processing subsystem 212 is further configured to identify at least one of: a start point and an end point, of the one or more tables based on the resultant coordinates and the one or more data types, upon determining the alignment of the one or more texts. In an embodiment, the end point is determined by the next significant change in alignment or the absence of the one or more integer values following the aligned one or more strings, which helps in accurately defining the boundaries of the table.

The document pre-processing subsystem 212 is further configured to segment the one or more entities into at least one of: the one or more rows and the one or more columns, based on the one or more data types and the resultant coordinates, to identify at least one of one or more headers and one or more labels of the one or more tables. This means that data elements aligned horizontally, are grouped into a same row, while the data elements aligned vertically are grouped into a same column. The data associated with the one or more strings identifies textual information, such as “Contracting Income” and “Over/Under Billings”, from the above example table. The data associated with the one or more integers identifies numerical values, such as “$21,935,113.58” and “$61,720,144.21”, from the above example table. In an embodiment, date type data may specify that if any date-type entity is present during the start of table identification, the date type data are taken into consideration as the column header. In an embodiment, the identification of the date type data is performed using a date parser model which matches the date type data with different types of date formats and stores as the column header.

In an alternative embodiment, the data associated with at least one of: the one or more strings, the one or more integers, and the date type data, are segmented based on the presence of string data and numeric data, which helps in identifying the headers or labels in the table. Additionally, when the numeric data follow the string data and are then followed by another string data, the numeric data mark the end of the line item, which helps in clearly defining the boundaries of each row. By following this process, the document pre-processing subsystem 212 may effectively identify and segment tables within the data, organizing the tables into rows based on their spatial and data type characteristics.

Upon identifying at least one of: the start point and the end point, the document pre-processing subsystem 212 is further configured to convert the extracted one or more texts into one or more structured tabular formats based on the start point, the end point, and the segmented one or more entities.

In the case of Excel files, the document pre-processing subsystem 212 utilizes an extensive rule-based approach. The document pre-processing subsystem 212 with the rule-based approach is configured to utilize an inherent structure of Excel sheets, including at least one of: cell formatting, merged cells, and header identification, to accurately detect and construct the tables. The rules are designed to handle one or more table formats and ensure that the tables are correctly identified and constructed. The final output clearly distinguishes between different tables, facilitating further processing or analysis. By combining various rule-based approaches, the document pre-processing subsystem 212 ensures a robust and accurate table detection and construction process.

The document pre-processing subsystem 212 is further configured to convert the tabular structured data to an operable 2-dimensional labelled data structure. The document pre-processing subsystem 212 is further configured to standardize the data to match the output requirements like sanitation (i.e., removing whitespaces/special characters) and ordering. The document pre-processing subsystem 212 is further configured to concatenate additional columns due to indentation present in the original documents to match the output requirements. The document pre-processing subsystem 212 is further configured to remove the non-relevant rows through an extensive rule based approach, so that the document pre-processing subsystem 212 ensures all the table headers are correctly captured and minimizes the chances of misclassification.

Ultimately, the document pre-processing subsystem 212 is further configured to obtain the output of the tabular data processing module into a noise removal module. In an embodiment, the noise removal module may include a rule engine configured to receive and store the one or more custom noise removal rules pertaining to the one or more documents. The document pre-processing subsystem 212 with the noise removal module is configured to filter at least one of: one or more common language stop words, one or more non-alphabetic characters, and one or more special characters, from the one or more texts to generate the one or more pre-processed data, based on one or more custom noise removal rules.

The plurality of subsystems 110 further includes the document classification subsystem 214 that is communicatively connected to the one or more hardware processors 204. The document classification subsystem 214 is configured to classify the one or more documents as at least one of: one or more relevant financial statements and one or more non-relevant financial statements, based on the pre-processed data using a voting classifier with one or more machine learning (ML) models.

For classifying the one or more documents, the document classifying subsystem 214 is initially configured to obtain the pre-processed data from the document pre-processing subsystem 212. The document classifying subsystem 214 is further configured to convert one or more strings indicating textual data into a numerical format, using a Term Frequency-Inverse Document Frequency (TFIDF) vectorizer. In an embodiment, the TFIDF vectorizer is configured to utilize one or more features to indicate the textual data.

The document classifying subsystem 214 is further configured to predict an issue of class imbalance by adjusting at least one of: one or more class weights and one or more hyperparameters, using a first ML model of the one or more ML models. The document classifying subsystem 214 is further configured to rectify potential losses in precision due to the class imbalance predicted by the first ML model, using a second ML model of the one or more ML models. The document classifying subsystem 214 is further configured to combine one or more votes provided by at least one of: the first ML model and the second ML model, for predicted classes associated with the one or more financial statements, using the voting classifier with majority voting mechanism. The document classifying subsystem 214 is further configured to classify the one or more documents as the one or more financial statements based on a majority of votes provided by the at least one of: the first ML model and the second ML model.

In the majority voting mechanism, each (i.e., the first ML model and the second ML model) of the one or more ML models casts a vote for the predicted classes associated with the one or more financial statements. The predicted classes associated with the one or more financial statements receiving the majority of votes, are selected as a final prediction. In an embodiment, the one or more ML models may be dual Light Gradient Boosting Machine (LightGBM) models. In an embodiment, the document classifying subsystem 214 is configured to utilize gradient boosting techniques to classify the financial documents as at least one of: the one or more relevant financial statements and the one or more non-relevant financial statements, based on the pre-processed data using the voting classifier with the one or more machine learning (ML) models (e.g., LightGBM models).

Typically, in a traditional single model approach using LightGBM, a single model is trained on an entire dataset, which may lead to biased predictions, especially in cases of class imbalance. This may result in poor performance for the minority class, as the model may prioritize the majority class during training. When compared to the traditional single model approach, the ML-based system 104 utilizes the voting classifier approach that utilizes two distinct ML models (e.g., LGBM models). By aggregating predictions from two different LightGBM models, the voting classifier achieves higher accuracy than any individual model, as the voting classifier leverages the strengths of each model.

The plurality of subsystems 110 further includes the training subsystem 218 that is communicatively connected to the one or more hardware processors 204. The training subsystem 218 is configured to train the one or more ML models. For training the one or more ML models, the training subsystem 218 is initially configured to obtain one or more training datasets including one or more types (e.g., 5000+ types of samples) of the one or more documents. The training subsystem 218 is further configured to train the one or more ML models independently on the one or more training datasets for classifying the one or more documents. The training subsystem 218 is further configured to fine-tune at least one of: the first ML model to manage the class imbalance, and the second ML model to maintain the precision in managing the class imbalance.

In an embodiment, the one or more ML models may be different in terms of their objectives and hyperparameters used during training. The details of the hyperparameters are shown in below table.

| | | Value used for second |
|---|---|---|
| | Value used for first | LightGBM model to |
| | LightGBM model to | compensate for precision loss |
| Hyperparameter | address class imbalance | (reduce false positives) |
| learning_rate - This | 0.1 (adjusted for faster | 0.01 (lower value for |
| parameter controls how | learning) | gradual learning) |
| much to change the ML | | |
| model in response to the | | |
| estimated error each time | | |
| the model weights are | | |
| updated | | |
| class_weight - This | ‘balanced’ (automatically | None (equal weight across |
| parameter adjusts the | adjusts weights based on | all classes. This ensures |
| importance of different | class frequencies. This | that the precision doesn't |
| classes during model | helps in improving recall | drop too much due to this |
| training, allowing the | for minority classes) | adjustment) |
| model to focus more on | | |
| underrepresented classes | | |
| num_leaves - This | 31 (lower value to | 63 (increased to capture |
| parameter specifies the | decrease the penalty so | more complex patterns |
| minimum number of data | that model is more lenient | and reduce the false |
| points required in a leaf | towards prediction | positives that would occur |
| node | increasing the recall) | due to the first model) |
| scale_pos_weight - This | 2.0 (adjusted to give more | 1.0 (default value, |
| parameter adjusts the | weight to the minority | indicating no additional |
| weight of the positive class | class) | weighting) |
| in the loss function | | |

In an embodiment, each hyperparameter is tuned using a grid search approach to determine the best hyperparameters from a predefined set of options. In an embodiment, each ML model may effectively contribute to the overall performance of the voting classifier, ensuring that both class imbalance and precision are adequately addressed. In an embodiment, the performance of the voting classifier using a classification report that includes at least one of: precision, recall, and F1-score metrics for each class, as well as overall accuracy. In an embodiment, the classification report indicates a high level of accuracy, suggesting that the ML model is effective in correctly classifying the financial statements. The ML model is saved in a cloud storage and is called a pre-trained ML model. The pre-trained ML model is then used for classifying any new document coming into the ML-based system 104.

The document classifying subsystem 214 is further configured to re-classify the classified one or more non-relevant financial statements into the one or more relevant financial statements using at least one of: the rule-based classification technique and the classifier model, to mitigate false positive categorization of the one or more documents. For re-classifying the classified one or more non-relevant financial statements into the one or more relevant financial statements, the document classifying subsystem 214 is initially configured to clean and format the text data before transforming the text data into a format suitable for the ML model. The columns in the table are fed to the pre-trained model and are classified into relevant and non-relevant categories and its data types are inferred while creating a list of potential document types. Only columns with concerned data type and classification category are kept in the data frame and sent to the rule engine.

The document classifying subsystem 214 is further configured to determine whether at least one of: one or more string columns, one or more integer columns, in one or more tables within the one or more documents, and a size of the one or more tables, are below a threshold value to classify the one or more documents as the one or more relevant financial statements, using at least one of: the rule-based classification technique and the classifier model. The document classifying subsystem 214 is further configured to re-classify the one or more non-relevant financial statements into the one or more relevant financial statements when the one or more non-relevant financial statements are classified based on a single category of data in the one or more documents, using at least one of: the rule-based classification technique and the classifier model. In other words, if only one category exists in the list of predicted potential document types, proceed to the reclassification engine of the document classifying subsystem 214, for final classification to rule out any possibility of misclassification.

The document classifying subsystem 214 is further configured to re-classify the one or more non-relevant financial statements into the one or more relevant financial statements when the one or more non-relevant financial statements are classified based on a plurality of categories of the data in the one or more documents, using at least one of: the rule-based classification technique and the classifier model. In other words, if the plurality of categories exist in the list of predicted potential document types, proceed to the reclassification engine of the document classifying subsystem 214 for final classification under one category.

In an embodiment, the ML model is used in conjunction with one or more predefined rules to predict the document type based on the table's content. The table where multiple categories are involved is segregated using column classification and then assigned their respective types. The predicted document type is assigned and sanitized table data are updated to table's metadata.

The plurality of subsystems 110 further includes the output subsystem 216 that is communicatively connected to the one or more hardware processors 204. The output subsystem 216 is configured to provide the re-categorized one or more electronic documents as the output, to the one or more users on the one or more user interfaces associated with the one or more electronic devices 102 associated with the one or more users. The output subsystem 216 is configured to integrate with the third-party database system, establishing a connection or utilizing appropriate APIs to facilitate data updates. The output subsystem 216 is configured to database types, including relational databases, NoSQL databases, document databases, or any other suitable database systems. The output subsystem 216 is configured to efficiently update the database 108 with the extracted information, ensuring real-time synchronization and data consistency between the extracted data and the target database. The output subsystem 216 is configured to provide mechanisms for error handling, transaction management, and data logging to maintain data integrity and traceability.

The plurality of subsystems 110 further includes the re-training subsystem 220 that is communicatively connected to the one or more hardware processors 204. The re-training subsystem 220 is initially configured to obtain one or more assessments of ML model predictions on data samples, from the one or more users. The one or more assessments from the one or more users may involve having human evaluators for reviewing a subset of predictions and providing their assessments (e.g., correct or incorrect). The re-training subsystem 220 is further configured to identify differences between the ML model predictions and the one or more assessments obtained from the one or more users, to determine whether the one or more ML models need to be optimized on the predictions. The re-training subsystem 220 is further configured to re-train the one or more ML models by at least one of: updating the pre-processed data, adjusting feature selection criteria, adjusting the one or more hyperparameters, based on one or more feedback received on the predictions. The re-training subsystem 220 is further configured to continuously monitor the model's performance and gather new assessments periodically. The ongoing feedback loop allows the model to adapt to evolving patterns in the data.

In an embodiment, upon training the ML model, the ML model may be deployed to a cloud production environment. The cloud production environment may be any cloud computing platform, including at least one of: Amazon Web Services (AWS), Microsoft Azure, Google Cloud Platform (GCP), and the like. In an embodiment, the ML model may be deployed to the cloud production environment using any standard ML framework. For example, the ML model may be deployed using TensorFlow, PyTorch, scikit-learn, and the like.

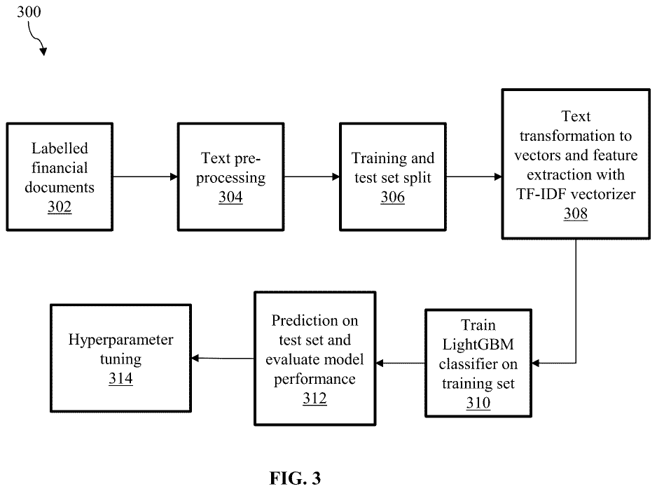

FIG. 3 is a training process of one or more ML models for automatically categorizing the one or more documents and extracting the data from the one or more documents, in accordance with another embodiment of the present disclosure. At step 302, the one or more documents are used as an input for pre-processing the texts, as shown in step 304. At step 306, the training and testing datasets are split. At step 308, the one or more texts are converted to one or more vectors using the TFIDF vectorizer. In an embodiment, the TFIDF vectorizer is configured to utilize the one or more features to indicate the textual data.

At step 310, the one or more ML models (e.g., LightGBM classifier models) are trained on the one or more training datasets. At step 312, the prediction on at least one of: the issue of class imbalance and the potential losses in precision due to the class imbalance, is performed on the testing datasets. The performance of the one or more ML models are evaluated. At step 314, the one or more hyperparameters are fine-tuned using the grid search approach to determine the best hyperparameters, so that each ML model may effectively contribute to the overall performance of the voting classifier with the one or more ML models.

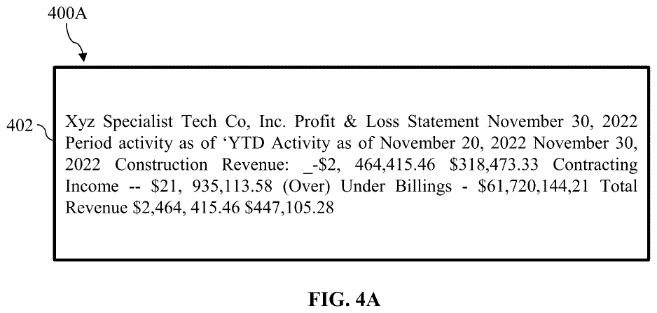

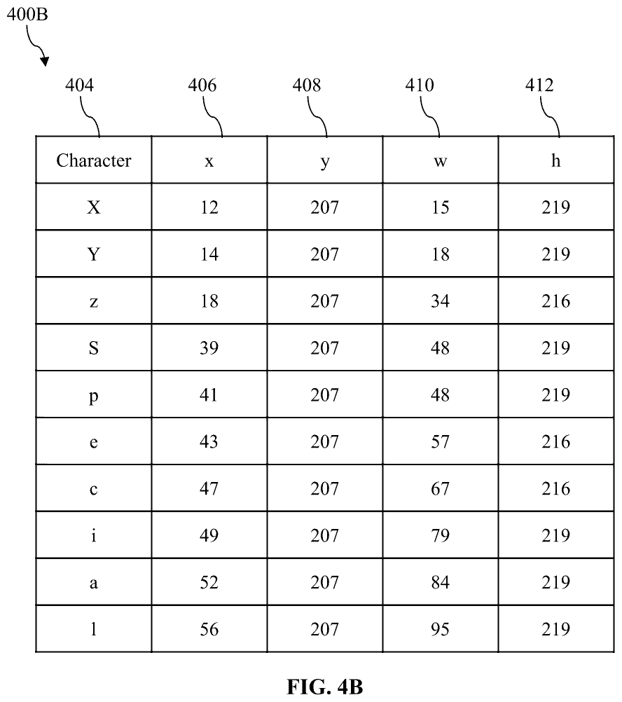

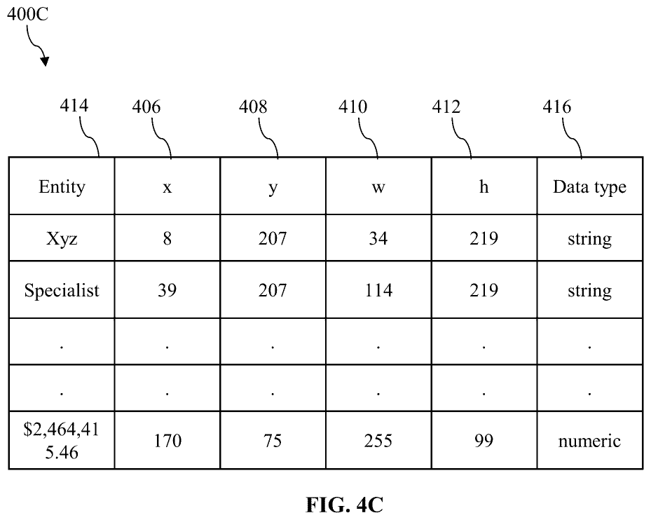

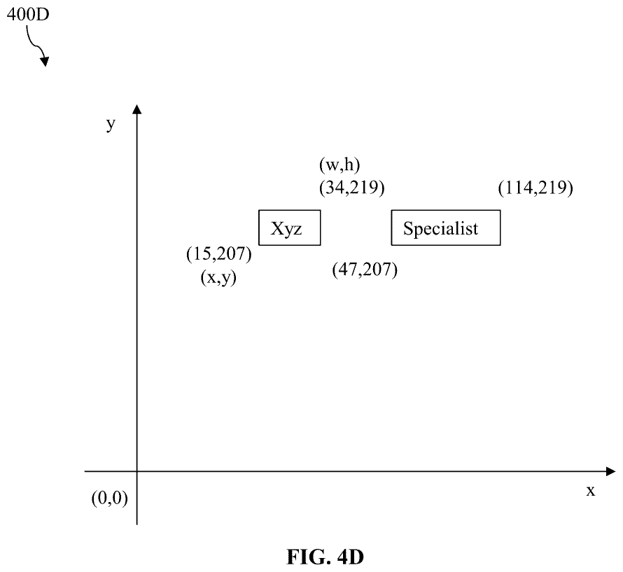

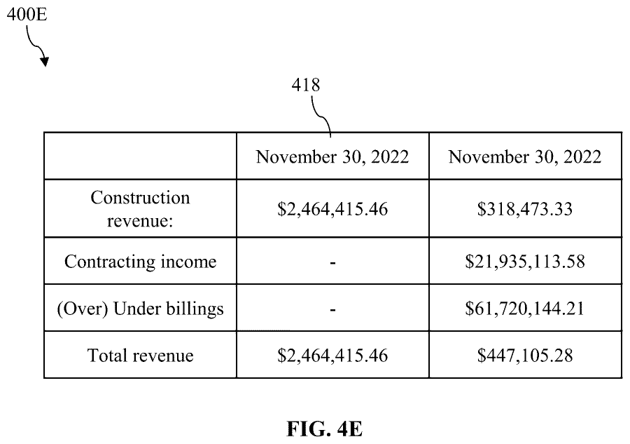

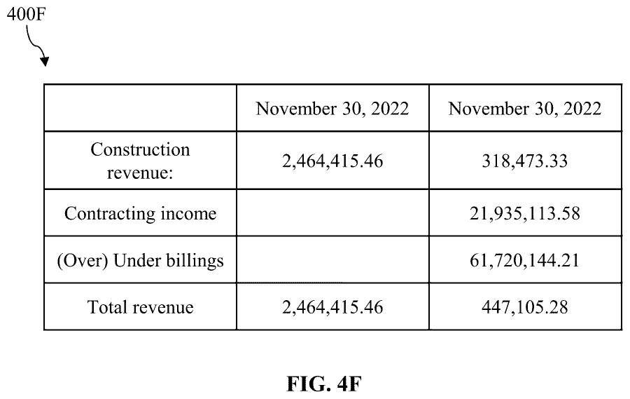

FIGS. 4A-4F represent one or more processes for converting the extracted one or more texts into one or more structured tabular formats, which are parts of processes of document categorization and data extraction from the one or more documents, in accordance with another embodiment of the present disclosure. FIG. 4A is exemplary view 400A representing a sample input 402 indicating the extracted unprocessed textual data (i.e., the one or more texts) using the parsing mechanism. FIG. 4B is an exemplary tabular view 400B depicting the coordinates of the one or more characters 404, where x 406 and y 408 represent the coordinates of the characters 404 in the two dimensional space of the PDF page. Further, w 410 and h 412, represent the width and height of space they occupy on the space grid.

FIG. 4C is an exemplary tabular view 400C depicting that the one or more coordinates of the one or more entities 414 and their respective data type 416 as formulated by the tabular data processing module of the document pre-processing subsystem 212. FIG. 4D illustrates a graphical representation 400D depicting the spatial data (i.e., spatial arrangements) of the one or more entities 414. The resultant coordinates of the one or more entities are analyzed for determining the alignment of the one or more texts. For example, the graphical representation 400D as shown in FIG. 4D, depicts that the words/entities 414 ‘Xyz’ and ‘Specialist’ have the same y coordinate 408, indicating that these words lie adjacent to each other on the same horizontal axis in the plane. Similarly, the same y coordinate 408 represents entities 414 present on the same vertical axis.

In an exemplary embodiment, at least one of: a start point and an end point, of the one or more tables is identified based on one or more strings followed by one or more integers. The table detection process performed by the tabular data processing module involves determining the coordinates of the one or more texts/entities. The tabular data processing module of the document pre-processing subsystem 212 checks for alignment by comparing the x-coordinates (horizontal position) of the one or more strings. If a plurality of strings share similar x or y coordinates and are followed by integer values (which typically represent data entries), the alignment may suggest the presence of a table. For example, all these entities have the same y-coordinate, indicating that these words lie adjacent to each other on the same horizontal axis in the plane. Moreover due to placement of an string followed by an integer, the algo identifies the start and end points of the table. For example, as shown in FIG. 4D, the last row has entities “Total revenue” showing “$2,464,415.46” and “$447,105.28” have the same y-coordinate, indicating that these words lie adjacent to each other on the same horizontal axis in the plane. Therefore, the tabular data processing module of the document pre-processing subsystem 212 is configured to identify the start and end points of the table due to placement of the one or more strings followed by the one or more integers.

FIG. 4E illustrates an exemplary tabular view 400E depicting a processed tabular data where all similar x-coordinated entities are kept in a single row, while all similar y-coordinated entities are kept in a single column. Additionally, date entity 418 captured with similar y coordinate is kept as their respective column header. FIG. 4F illustrates an exemplary tabular view 400F depicting the processed tabular data after removal of noise. In this noise removal process, at least one of: the one or more common language stop words, the one or more non-alphabetic characters, and the one or more special characters, are filtered from the one or more texts to generate the one or more pre-processed data, based on the one or more custom noise removal rules.

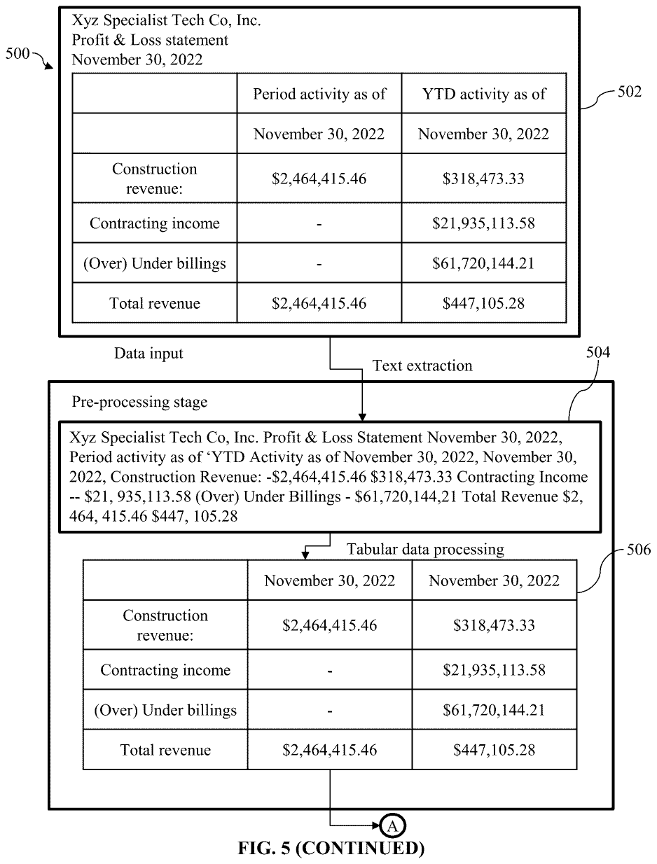

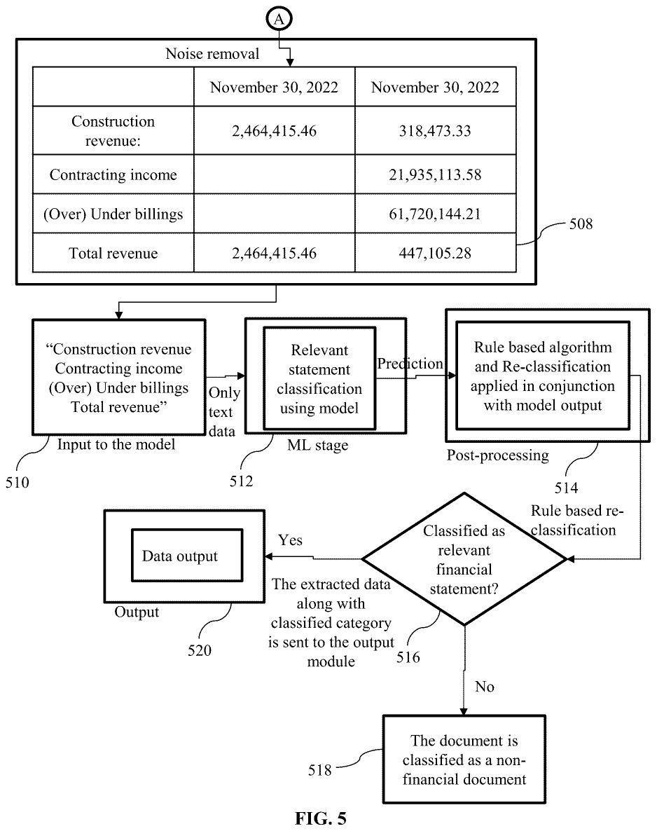

FIG. 5 is an exemplary process flow 500 for automatically categorizing the one or more documents and extracting the data from the one or more documents, in accordance with another embodiment of the present disclosure. At step 504, the one or more texts along with one or more coordinates of each word, are extracted (as described in FIG. 4A), within the one or more documents, as shown in step 502. At step 506, the extracted one or more texts are converted into the one or more structured tabular formats (as described in FIGS. 4B-4E), using the tabular data processing module. At step 508, at least one of: the one or more common language stop words, the one or more non-alphabetic characters, and the one or more special characters, are filtered/removed (as described in FIG. 4F) from the one or more texts to generate the one or more pre-processed data, based on the one or more custom noise removal rules.

At step 510, the one or more models are configured to obtain the pre-processed data. At step 512, the one or more documents are classified as the one or more financial statements based on the majority of votes provided by the at least one of: the first ML model and the second ML model, along with the voting classifier. At step 514, the classifier model with the rule-based classification technique is combined with the output of the one or more ML models to re-classify the classified one or more non-relevant financial statements into the one or more relevant financial statements (e.g., balance sheet, income statement, cash flow, and the like). At step 516, the document classifying subsystem 214 determines the one or more non-relevant financial statements are re-classified as one or more relevant financial statements. If no, the document classifying subsystem 214 classifies the one or more documents as the non-relevant financial statements, as shown in step 518. If yes, the document classifying subsystem 214 classifies the one or more documents as the relevant financial statements, as shown in step 520.

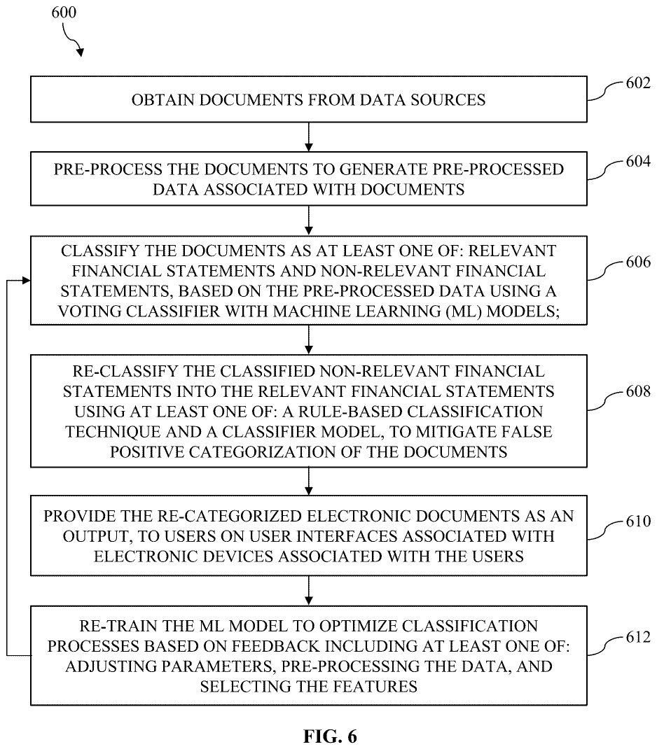

FIG. 6 is a flow chart illustrating a machine-learning based (ML-based) method 600 for automatically categorizing the one or more documents and extracting the data from the one or more documents, in accordance with an embodiment of the present disclosure. At step 602, the one or more documents are obtained from the one or more data sources 108. At step 604, the one or more documents are pre-processed to generate the pre-processed data associated with the one or more documents.

At step 606, the one or more documents are classified as at least one of: the one or more relevant financial statements and the one or more non-relevant financial statements, based on the pre-processed data using the voting classifier with the one or more machine learning (ML) models.

At step 608, the classified one or more non-relevant financial statements are re-classified into the one or more relevant financial statements using at least one of: the rule-based classification technique and the classifier model, to mitigate the false positive categorization of the one or more documents.

At step 610, the re-categorized one or more electronic documents are provided as the output, to the one or more users on the one or more user interfaces associated with the one or more electronic devices 102 associated with the one or more users.

At step 612, the one or more ML models are re-trained by at least one of: updating the pre-processed data, adjusting the feature selection criteria, adjusting the one or more hyperparameters, based on the one or more feedback received on the predictions.

The present invention has following advantages. The primary purpose of the present invention with the ML-based system 104 is to automatically categorize the one or more documents and extracting the data from the one or more documents. The present invention with the machine learning solution aims to transform the processing of the one or more financial documents by automating the parsing and extraction tasks. Utilizing cutting-edge machine learning techniques, the one or more models aspire to achieve high classification accuracy while effectively extracting relevant entities from the financial statements. The one or more ML models categorize the one or more documents into specific groups including at least one of: ‘Balance Sheet,’ ‘Income Statement,’ ‘Cash Flow Statement,’ or ‘Others,’ while concurrently extracting pertinent data and structuring the data into the tabular format with key-value pairs. This is accomplished with a focus on optimizing resource utilization and ensuring rapid processing capabilities.

The present invention utilizes an advanced optical character recognition (OCR) system known for its exceptional capture rate, delivering highly accurate results. The innovative approach integrates a TF-IDF vectorizer along with the voting classifier to categorize the one or more financial statements based on the content of the PDF, effectively removing the need for a predefined synonym list. Additionally, the present invention employs sophisticated techniques for table detection using coordinate mapping, ensuring precise identification of tables for further processing. Overall, this comprehensive methodology significantly outperforms traditional solutions, demonstrating unparalleled accuracy and efficiency in every aspect.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based system 104 either directly or through intervening I/O controllers. Network adapters may also be coupled to the ML-based system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based system 104 in accordance with the embodiments herein. The ML-based system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based system 104. The ML-based system 104 can read the inventive instructions on the program storage devices and follow these instructions to execute the methodology of the embodiments herein.

The ML-based system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine-learning based (ML-based) method for automatically categorizing one or more documents, the ML-based method comprising:
obtaining, by one or more hardware processors, the one or more documents from one or more data sources;
pre-processing, by the one or more hardware processors, the one or more documents to generate pre-processed data associated with the one or more documents;
classifying, by the one or more hardware processors, the one or more documents as at least one of: one or more relevant financial statements and one or more non-relevant financial statements, based on the pre-processed data using a voting classifier with one or more machine learning (ML) models;
re-classifying, by the one or more hardware processors, the classified one or more non-relevant financial statements into the one or more relevant financial statements using at least one of: a rule-based classification technique and a classifier model, to mitigate false positive categorization of the one or more documents; and
providing, by the one or more hardware processors, the re-categorized one or more electronic documents as an output, to one or more users on one or more user interfaces associated with one or more electronic devices associated with the one or more users.

2. The ML-based method of claim 1, wherein pre-processing the data associated with the one or more documents comprises extracting, by the one or more hardware processors, one or more texts along with one or more coordinates of each word within the one or more documents, using a parsing mechanism.

3. The ML-based method of claim 2, wherein pre-processing the data associated with the one or more documents further comprises converting, by the one or more hardware processors, the extracted one or more texts into one or more structured tabular formats, by:
identifying, by the one or more hardware processors, one or more potential table regions by analyzing the one or more documents using one or more pre-defined rules and heuristics, wherein the one or more pre-defined rules are based on at least one of: one or more domain knowledges and one or more inherent properties of table structures comprising spatial arrangements of at least one of: the one or more texts, one or more lines, and one or more cell formatting, and wherein the spatial arrangements are derived from the one or more coordinates of each word within the one or more documents;
identifying, by the one or more hardware processors, one or more boundaries of one or more tables by analyzing the spatial arrangements;
grouping, by the one or more hardware processors, one or more clustered characters associated with the one or more texts, into one or more entities, wherein resultant coordinates are derived to indicate each entity of the one or more entities in a two dimensional space;
setting, by the one or more hardware processors, at least one of: a first threshold value on a first coordinate of the resultant coordinates to differentiate each column of one or more columns, and a second threshold value on a second coordinate of the resultant coordinates to differentiate each row of one or more rows;
analyzing, by the one or more hardware processors, the resultant coordinates of the one or more entities for determining alignment of the one or more texts;
categorizing, by the one or more hardware processors, the one or more entities into one or more data types, wherein the one or more data types comprises at least one of: one or more strings, one or more integers, and one or more date type data;
upon determining the alignment of the one or more texts, identifying, by the one or more hardware processors, at least one of: a start point and an end point, of the one or more tables based on the resultant coordinates and the one or more data types;
segmenting, by the one or more hardware processors, the one or more entities into at least one of: the one or more rows and the one or more columns, based on the one or more data types and the resultant coordinates, to identify at least one of one or more headers and one or more labels of the one or more tables; and
converting, by the one or more hardware processors, the extracted one or more texts into one or more structured tabular formats based on the start point, the end point, and the segmented one or more entities.

4. The ML-based method of claim 3, wherein pre-processing the data associated with the one or more documents further comprises filtering, by the one or more hardware processors, at least one of: one or more common language stop words, one or more non-alphabetic characters, and one or more special characters, from the one or more texts to generate the one or more pre-processed data, based on one or more custom noise removal rules.

5. The ML-based method of claim 1, wherein classifying the one or more documents comprises:
obtaining, by the one or more hardware processors, the pre-processed data;
converting, by the one or more hardware processors, one or more strings indicating textual data into a numerical format, using a Term Frequency-Inverse Document Frequency (TFIDF) vectorizer, wherein the TFIDF vectorizer is configured to utilize one or more features to indicate the textual data;
predicting, by the one or more hardware processors, an issue of class imbalance by adjusting at least one of: one or more class weights and one or more hyperparameters, using a first ML model of the one or more ML models;
rectifying, by the one or more hardware processors, potential losses in precision due to the class imbalance predicted by the first ML model, using a second ML model of the one or more ML models;
combining, by the one or more hardware processors, one or more votes provided by at least one of: the first ML model and the second ML model, for predicted classes associated with the one or more financial statements, using a voting classifier with majority voting mechanism; and
classifying, by the one or more hardware processors, the one or more documents as the one or more financial statements based on a majority of votes provided by the at least one of: the first ML model and the second ML model.

6. The ML-based method of claim 1, further comprising training, by the one or more hardware processors, the one or more ML models, by:
obtaining, by the one or more hardware processors, one or more training datasets comprising one or more types of the one or more documents;
training, by the one or more hardware processors, the one or more ML models independently on the one or more training datasets for classifying the one or more documents; and
fine-tuning, by the one or more hardware processors, at least one of: the first ML model to manage the class imbalance, and the second ML model to maintain the precision in managing the class imbalance.

7. The ML-based method of claim 1, wherein re-classifying the classified one or more non-relevant financial statements into the one or more relevant financial statements, comprises at least one of:
determining, by the one or more hardware processors, whether at least one of: one or more string columns, one or more integer columns, in one or more tables within the one or more documents, and a size of the one or more tables, are below a threshold value to classify the one or more documents as the one or more relevant financial statements, using at least one of: the rule-based classification technique and the classifier model;
re-classifying, by the one or more hardware processors, the one or more non-relevant financial statements into the one or more relevant financial statements when the one or more non-relevant financial statements are classified based on a single category of data in the one or more documents, using at least one of: the rule-based classification technique and the classifier model; and
re-classifying, by the one or more hardware processors, the one or more non-relevant financial statements into the one or more relevant financial statements when the one or more non-relevant financial statements are classified based on a plurality of categories of the data in the one or more documents, using at least one of: the rule-based classification technique and the classifier model.

8. The ML-based method of claim 5, further comprising re-training, by the one or more hardware processors, the one or more ML models by:
obtaining, by the one or more hardware processors, one or more assessments of ML model predictions on data samples, from the one or more users;
identifying, by the one or more hardware processors, differences between the ML model predictions and the one or more assessments obtained from the one or more users, to determine whether the one or more ML models need to be optimized on the predictions; and
re-training, by the one or more hardware processors, the one or more ML models by at least one of: updating the pre-processed data, adjusting feature selection criteria, adjusting the one or more hyperparameters, based on one or more feedback received on the predictions.

9. A machine learning based (ML-based) system for automatically categorizing one or more documents, the ML-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a document obtaining subsystem configured to obtain the one or more documents from one or more data sources;
a document pre-processing subsystem configured to pre-process the one or more documents to generate pre-processed data associated with the one or more documents;
a document classifying subsystem configured to:
classify the one or more documents as at least one of: one or more relevant financial statements and one or more non-relevant financial statements, based on the pre-processed data using a voting classifier with one or more machine learning (ML) models; and
re-classify the classified one or more non-relevant financial statements into the one or more relevant financial statements using at least one of: a rule-based classification technique and a classifier model, to mitigate false positive categorization of the one or more documents; and
an output subsystem configured to provide the re-categorized one or more electronic documents as an output, to one or more users on one or more user interfaces associated with one or more electronic devices associated with the one or more users.

10. The ML-based system of claim 9, wherein in pre-processing the data associated with the one or more documents, the document pre-processing subsystem is configured to extract one or more texts along with one or more coordinates of each word within the one or more documents, using a parsing mechanism.

11. The ML-based system of claim 10, wherein in pre-processing the data associated with the one or more documents, the document pre-processing subsystem is further configured to convert the extracted one or more texts into one or more structured tabular formats, by:
identifying one or more potential table regions by analyzing the one or more documents using one or more pre-defined rules and heuristics, wherein the one or more pre-defined rules are based on at least one of: one or more domain knowledges and one or more inherent properties of table structures comprising spatial arrangements of at least one of: the one or more texts, one or more lines, and one or more cell formatting, and wherein the spatial arrangements are derived from the one or more coordinates of each word within the one or more documents;
identifying one or more boundaries of the one or more tables by analyzing the spatial arrangements;
grouping one or more clustered characters associated with the one or more texts, into one or more entities, wherein resultant coordinates are derived to indicate each entity of the one or more entities in a two dimensional space;
setting at least one of: a first threshold value on a first coordinate of the resultant coordinates to differentiate each column of one or more columns, and a second threshold value on a second coordinate of the resultant coordinates to differentiate each row of one or more rows;
analyzing the resultant coordinates of the one or more entities for determining alignment of the one or more texts;
categorizing, by the one or more hardware processors, the one or more entities into one or more data types, wherein the one or more data types comprises at least one of: one or more strings, one or more integers, and one or more date type data;
upon determining the alignment of the one or more texts, identifying at least one of: a start point and an end point, of the one or more tables based on the resultant coordinates and the one or more data types;
segmenting the one or more entities into at least one of: the one or more rows and the one or more columns, based on the one or more data types and the resultant coordinates, to identify at least one of one or more headers and one or more labels of the one or more tables; and
converting the extracted one or more texts into one or more structured tabular formats based on the start point, the end point, and the segmented one or more entities.

12. The ML-based system of claim 11, wherein in pre-processing the data associated with the one or more documents, the document pre-processing subsystem is further configured to filter at least one of: one or more common language stop words, one or more non-alphabetic characters, and one or more special characters, from the one or more texts to generate the one or more pre-processed data, based on one or more custom noise removal rules.

13. The ML-based system of claim 9, wherein in classifying the one or more documents, the document classifying subsystem is configured to:
obtain the pre-processed data;
convert one or more strings indicating textual data into a numerical format, using a Term Frequency-Inverse Document Frequency (TFIDF) vectorizer, wherein the TFIDF vectorizer is configured to utilize one or more features to indicate the textual data;
predict an issue of class imbalance by adjusting at least one of: one or more class weights and one or more hyperparameters, using a first ML model of the one or more ML models;
rectify potential losses in precision due to the class imbalance predicted by the first ML model, using a second ML model of the one or more ML models;
combine one or more votes provided by at least one of: the first ML model and the second ML model, for predicted classes associated with the one or more financial statements, using a voting classifier with majority voting mechanism; and
classify the one or more documents as the one or more financial statements based on a majority of votes provided by the at least one of: the first ML model and the second ML model.

14. The ML-based system of claim 9, further comprising a training subsystem configured to train the one or more ML models, by:
obtaining one or more training datasets comprising one or more types of the one or more documents;
training the one or more ML models independently on the one or more training datasets for classifying the one or more documents; and
fine-tuning at least one of: the first ML model to manage the class imbalance, and the second ML model to maintain the precision in managing the class imbalance.

15. The ML-based system of claim 9, wherein in re-classifying the classified one or more non-relevant financial statements into the one or more relevant financial statements, the document classifying subsystem is further configured to at least one of:
determine whether at least one of: one or more string columns, one or more integer columns, in one or more tables within the one or more documents, and a size of the one or more tables, are below a threshold value to classify the one or more documents as the one or more relevant financial statements, using at least one of: the rule-based classification technique and the classifier model;
re-classify the one or more non-relevant financial statements into the one or more relevant financial statements when the one or more non-relevant financial statements are classified based on a single category of data in the one or more documents, using at least one of: the rule-based classification technique and the classifier model; and
re-classify the one or more non-relevant financial statements into the one or more relevant financial statements when the one or more non-relevant financial statements are classified based on a plurality of categories of the data in the one or more documents, using at least one of: the rule-based classification technique and the classifier model.

16. The ML-based system of claim 13, wherein the training subsystem is further configured to:
obtain one or more assessments of ML model predictions on data samples, from the one or more users;
identify differences between the ML model predictions and the one or more assessments obtained from the one or more users, to determine whether the one or more ML models need to be optimized on the predictions; and
re-train the one or more ML models by at least one of: updating the pre-processed data, adjusting feature selection criteria, adjusting the one or more hyperparameters, based on one or more feedback received on the predictions.

17. A non-transitory computer-readable storage medium having instructions stored therein that when executed by one or more hardware processors, cause the one or more hardware processors to execute operations of:
obtaining the one or more documents from one or more data sources;
pre-processing the one or more documents to generate pre-processed data associated with the one or more documents;
classifying the one or more documents as at least one of: one or more relevant financial statements and one or more non-relevant financial statements, based on the pre-processed data using a voting classifier with one or more machine learning (ML) models;
re-classifying the classified one or more non-relevant financial statements into the one or more relevant financial statements using at least one of: a rule-based classification technique and a classifier model, to mitigate false positive categorization of the one or more documents; and
providing the re-categorized one or more electronic documents as an output, to one or more users on one or more user interfaces associated with one or more electronic devices associated with the one or more users.

18. The non-transitory computer-readable storage medium of claim 17, wherein pre-processing the data associated with the one or more documents further comprises converting one or more texts into one or more structured tabular formats, by:
identifying one or more potential table regions by analyzing the one or more documents using one or more pre-defined rules and heuristics, wherein the one or more pre-defined rules are based on at least one of: one or more domain knowledges and one or more inherent properties of table structures comprising spatial arrangements of at least one of: the one or more texts, one or more lines, and one or more cell formatting, and wherein the spatial arrangements are derived from the one or more coordinates of each word within the one or more documents;
identifying one or more boundaries of one or more tables by analyzing the spatial arrangements;
grouping one or more clustered characters associated with the one or more texts, into one or more entities, wherein resultant coordinates are derived to indicate each entity of the one or more entities in a two dimensional space;
setting at least one of: a first threshold value on a first coordinate of the resultant coordinates to differentiate each column of one or more columns, and a second threshold value on a second coordinate of the resultant coordinates to differentiate each row of one or more rows;
analyzing the resultant coordinates of the one or more entities for determining alignment of the one or more texts;
categorizing the one or more entities into one or more data types, wherein the one or more data types comprises at least one of: one or more strings, one or more integers, and one or more date type data;
upon determining the alignment of the one or more texts, identifying at least one of: a start point and an end point, of the one or more tables based on the resultant coordinates and the one or more data types;
segmenting the one or more entities into at least one of: the one or more rows and the one or more columns, based on the one or more data types and the resultant coordinates, to identify at least one of one or more headers and one or more labels of the one or more tables; and
converting the extracted one or more texts into one or more structured tabular formats based on the start point, the end point, and the segmented one or more entities.

19. The non-transitory computer-readable storage medium of claim 17, wherein classifying the one or more documents comprises:
obtaining the pre-processed data;
converting one or more strings indicating textual data into a numerical format, using a Term Frequency-Inverse Document Frequency (TFIDF) vectorizer, wherein the TFIDF vectorizer is configured to utilize one or more features to indicate the textual data;
predicting an issue of class imbalance by adjusting at least one of: one or more class weights and one or more hyperparameters, using a first ML model of the one or more ML models;
rectifying potential losses in precision due to the class imbalance predicted by the first ML model, using a second ML model of the one or more ML models;
combining one or more votes provided by at least one of: the first ML model and the second ML model, for predicted classes associated with the one or more financial statements, using a voting classifier with majority voting mechanism; and
classifying the one or more documents as the one or more financial statements based on a majority of votes provided by the at least one of: the first ML model and the second ML model.

20. The non-transitory computer-readable storage medium of claim 17, further comprising training the one or more ML models, by:
obtaining one or more training datasets comprising one or more types of the one or more documents;
training the one or more ML models independently on the one or more training datasets for classifying the one or more documents; and
fine-tuning at least one of: the first ML model to manage the class imbalance, and the second ML model to maintain the precision in managing the class imbalance.
